(19) United States
(12) Patent Application Publication
(10) Pub. No.: US 2021/0390422 A1
(43) Pub. Date: Dec. 16, 2021

(54) Knowledge-Base Information Sensing Method And System For Operations And Maintenance Of Data Center

(71) Applicant: Shanghai Data Center Science Co., Ltd, Shanghai (CN)

(72) Inventors: Jun Zhang, Shanghai (CN); He Liu, Shanghai (CN); Jie Zhang, Shanghai (CN)

(73) Assignee: Shanghai Data Center Science Co., Ltd, Shanghai (CN)

(21) Appl. No.: 17/283,535

(22) PCT Filed: Mar. 25, 2020
(86) PCT No.: PCT/CN2020/081050

§ 371 Date: Apr. 7, 2021

(30) Foreign Application Priority Data
Mar. 27, 2019 (CN) 201910240602.7

(51) Int. Cl. G06N 5/02; G06F 11/30; G06F 11/32; G06F 11/07; G06F 16/23

(52) U.S. Cl. CPC G06N 5/022; G06F 11/3051; G06F 16/2358; G06F 11/0766; G06F 11/302; G06F 11/321

(57) ABSTRACT

Provided is a knowledge base information awareness method and system based on operation and maintenance of a data center. The method includes that: a data collector collects basic resource information of the data center; a data analyzer analyzes the basic resource information, and determines whether information of an information node of the data center is updated to obtain a determination result and an update parameter; a context retriever establishes an index for context information stored in a knowledge base, and performs retrieval; a monitor monitors updates of the context information and the information node; when the monitor monitors that the context information and/or the information node is updated, the monitor performs an adaptive management through an operation and maintenance related body, and triggers a problem manager; the problem manager sends a processing scheme corresponding to a fault identification result to a uniform service management software platform for performing.

The present application claims priority to Chinese Patent Application No. 201910240602.7 filed with the CNIPA on Mar. 27, 2019, the disclosure of which is incorporated herein by reference in its entirety.

### TECHNICAL FIELD

The present application relates to the technical field of computer operation and maintenance, and for example, to knowledge base information awareness method and system based on operation and maintenance of a data center.

### BACKGROUND

As cloud calculation and virtualization present characteristics such as “large scale”, “high density”, “high energy consumption”, and “complexity”, the construction and development of a new generation of data center and the improvement of infrastructure management of the data center will become increasingly important, and the infrastructure fusion management and intelligence of the data center will become a new trend of the development of the data center.

Pervasive calculating refers to ubiquitous calculating. Context-aware calculating has become a core research topic in pervasive calculating projects. Context is a kind of information that may be used for describing a situation of an entity. The entity may be a person, a place, or an object that is considered to interact with a user and an application, including the user and the application itself. Whether a system is context-aware depends on whether the system provides the user with relevant information and services based on context information, and the relevance depends on the tasks of the user.

In a pervasive calculating environment, the system must be aware of dynamically changing context information and take corresponding actions. Therefore, to meet these requirements, awareness and application development need to be separated, that is, a lower-layer awareness data processing and a higher-layer context awareness application are separated. Context awareness introduces a hierarchical structure for avoiding awareness details at the lower layer and providing necessary context awareness services for the application.

The concept of the knowledge base comes from two different fields, one field is an artificial intelligence field and its branch, knowledge engineering field, and the other field is a traditional database field. The organic combination of two computer technologies, the artificial intelligence and the database, promotes the generation and development of a knowledge base system. However, the management pressure is brought due to lack of an automatic means, passive operation and maintenance, a low efficiency and a large-scale information technology (IT) facility.

Therefore, how to improve the efficiency of the operation and maintenance of the data center is an urgent problem needing to be solved by those skilled in the art.

### SUMMARY

The present application provides knowledge base information awareness method and system based on operation and maintenance of a data center, to intelligently monitor a device of the data center, so that the automatic control is achieved, the efficiency of the operation and maintenance is greatly improved, and the labor is reduced.

A knowledge base information awareness method based on operation and maintenance of a data center is provided and includes that: a data collector collects basic resource information of the data center; a data analyzer analyzes the basic resource information, and determines whether information of an information node of the data center is updated to obtain a determination result and an update parameter; a context retriever establishes an index for context information stored in a knowledge base, and retrieves the context information to obtain a retrieval result; a monitor monitors an update of the context information according to the retrieval result, and monitors an update of the information node according to the determination result and the update parameter; in a case where the monitor monitors that at least one of the context information or the information node is updated, the monitor performs an adaptive management through an operation and maintenance related body, and triggers a problem manager; where the adaptive management includes a fault identification of the information node of the data center; the problem manager sends a processing scheme corresponding to a fault identification result to a uniform service management software platform according to the fault identification result, a fault information problem stored in the knowledge base and a processing scheme corresponding to the fault information problem; and the uniform service management software platform performs the processing scheme corresponding to the fault identification result.

A knowledge base information awareness system based on operation and maintenance of a data center is provided and includes the data center, a data collector, a knowledge base, a data analyzer, a context retriever, a monitor, an operation and maintenance related body, a problem manager and a uniform service management software platform. The data collector is connected to the data center and configured to collect basic resource information of the data center. The data analyzer is connected to the data collector and configured to analyze the basic resource information and determine whether information of an information node of the data center is updated to obtain a determination result and an update parameter. The context retriever is connected to the knowledge base and configured to establish an index for context information stored in the knowledge base and retrieve the context information to obtain a retrieval result.

The monitor is connected to the context retriever, the data analyzer, the operation and maintenance related body and the problem manager, and the monitor is configured to monitor an update of the context information according to the retrieval result, monitor an update of the information node according to the determination result and the update parameter, and in a case of monitoring that at least one of the context information or the information node is updated, perform an adaptive management through the operation and maintenance related body and trigger the problem manager; where the adaptive management includes a fault identification of the information node of the data center. The problem manager is connected to the uniform service management software platform and configured to send a processing scheme corresponding to a fault identification result to the uniform service management software platform according to the fault identification result, a fault information problem stored in the knowledge base and a processing scheme corresponding to the fault information problem. The uniform service management software platform is configured to perform the processing scheme corresponding to the fault identification result.

### BRIEF DESCRIPTION OF DRAWINGS

The drawings, which need to be used in the description of embodiments or related art, are briefly introduced below.

FIG. 1 is a flowchart of a knowledge base information awareness method based on operation and maintenance of a data center according to the present application; and

FIG. 2 is a schematic structural diagram of a knowledge base information awareness system based on operation and maintenance of a data center according to the present application.

### DETAILED DESCRIPTION

Technical schemes in embodiments of the present application will be described below in conjunction with the drawings in the embodiments of the present application.

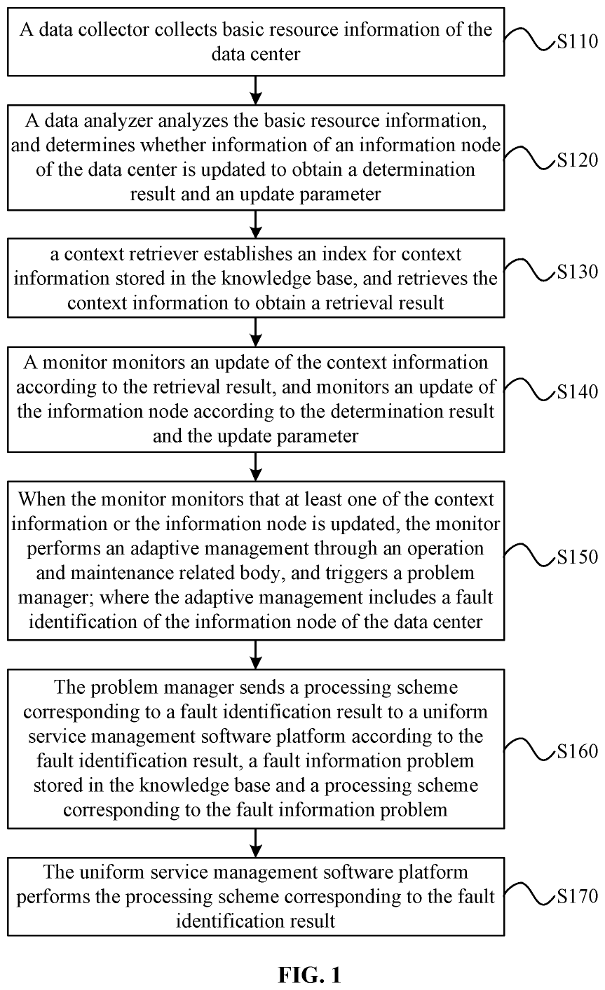

FIG. 1 is a flowchart of a knowledge base information awareness method based on operation and maintenance of a data center according to the present application. As shown in FIG. 1, an embodiment of the present application discloses a knowledge base information awareness method based on operation and maintenance of a data center, the method includes described below.

In step S110, a data collector collects basic resource information of the data center.

In step S120, a data analyzer analyzes the basic resource information, and determines whether information of an information node of the data center is updated to obtain a determination result and an update parameter.

In an embodiment, the information node may be a sensor, a camera and another device. The information of the information node may be parameter information corresponding to the information node.

In an embodiment, the data analyzer compares the basic resource information collected by the data collector with historical basic resource information stored in a knowledge base, and determines whether the information of the information node of the data center is updated according to a comparison result.

In an embodiment, in a case where it is confirmed that the basic resource information collected by the data collector is not stored in the historical basic resource information in the knowledge base according to the comparison result, it is confirmed that the information of the information node of the data center is updated, and the update parameter may include the collected basic resource information. In a case where it is confirmed that the basic resource information collected by the data collector is stored in the historical basic resource information in the knowledge base according to the comparison result, it is confirmed that the information of the information node of the data center is not updated, and the update parameter may be null or a set value.

In step S130, a context retriever establishes an index for context information stored in the knowledge base, and retrieves the context information to obtain a retrieval result.

In an embodiment, the context information is collected by the information node of the data center. The step in which the context retriever retrieves the context information includes that: the context retriever retrieves, in a case of confirming that new context information is collected by the information node of the data center, the collected new context information in the context information stored in the knowledge base.

In step S140, a monitor monitors an update of the context information according to the retrieval result, and monitors an update of the information node according to the determination result and the update parameter.

In step S150, when the monitor monitors that at least one of the context information or the information node is updated, the monitor performs an adaptive management through an operation and maintenance related body, and triggers a problem manager; where the adaptive management includes a fault identification of the information node of the data center.

In step S160, the problem manager sends a processing scheme corresponding to a fault identification result to a uniform service management software platform according to the fault identification result, a fault information problem stored in the knowledge base and a processing scheme corresponding to the fault information problem.

In step S170, the uniform service management software platform performs the processing scheme corresponding to the fault identification result.

According to the knowledge base information awareness method based on the operation and maintenance of the data center provided by the embodiments of the present application, in a case where the monitor monitors that the context information is updated and/or that the information node of the data center is updated according to the determination result and the update parameter, a processing scheme is sent to the uniform service management software platform according to the fault information problem stored in the knowledge base in advance and a processing step and processing scheme corresponding to the fault information problem, and the uniform service management software platform performs the processing scheme. Therefore, the intelligent monitoring of the device of the data center is achieved, automatic management and operation and maintenance such as automatic alarm and automatic control can be achieved based on the update and change of the context information and/or the information node, the efficiency of the operation and maintenance is greatly improved, and the labor is reduced.

In an embodiment, the method further includes that: an interpreter provides a service for the monitor and the context retriever, where the service includes a translation of a high-level programming language.

In an embodiment, the method further includes that: a content stored in the knowledge base is updated.

In an embodiment, the basic resource information includes at least one of network device information, database information, physical host information or virtual host information, or application system information.

In an embodiment, the method further includes that: a uniform entry module displays information of the data center.

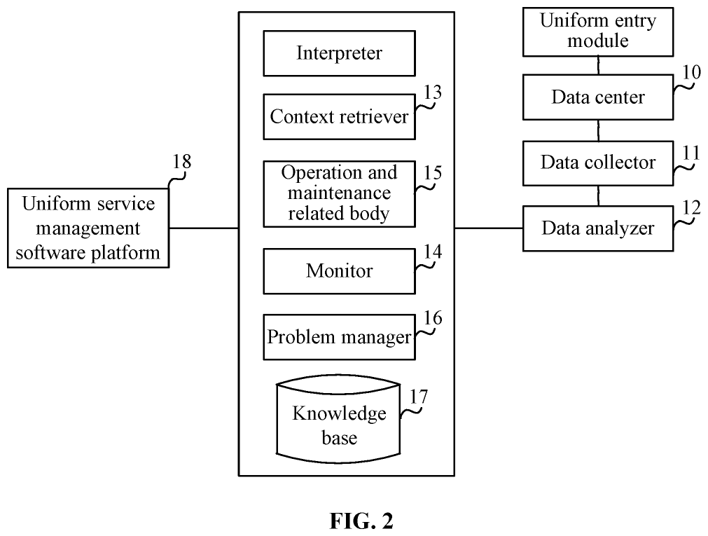

FIG. 2 is a schematic structural diagram of a knowledge base information awareness system based on operation and maintenance of a data center according to the present application. As shown in FIG. 2, an embodiment of the present application discloses a knowledge base information awareness system based on operation and maintenance of a data center. The system includes a data center 10, a data collector 11, a data analyzer 12, a context retriever 13, a monitor 14, an operation and maintenance related body 15, a problem manager 16, a knowledge base 17 and a uniform service management software platform 18.

In this embodiment, the data collector 11 is connected to the data center 10 and configured to collect basic resource information of the data center 10.

In this embodiment, the data analyzer 12 is connected to the data collector 11, and the data analyzer 12 is configured to analyze the basic resource information and determine whether information of an information node of the data center 10 is updated to obtain a determination result and an update parameter. In an embodiment, the information node may be a sensor corresponding to a device of the digital center. The information of the information node may be parameter information corresponding to the information node.

In this embodiment, the context retriever 13 is connected to the knowledge base 17 and configured to establish an index for context information stored in the knowledge base 17 and retrieve the context information to obtain a retrieval result.

In this embodiment, the monitor 14 is connected to the context retriever 13, the data analyzer 12, the operation and maintenance related body 15 and the problem manager 16, and the monitor 14 is configured to monitor an update of the context information according to the retrieval result, monitor an update of the information node according to the determination result and the update parameter, and in a case of monitoring that at least one of the context information or the information node is updated, perform an adaptive management through the operation and maintenance related body and trigger the problem manager 16; where the adaptive management includes a fault identification of the information node of the data center.

In this embodiment, the problem manager 16 is connected to the uniform service management software platform 18, and the problem manager 16 is configured to send a processing scheme corresponding to a fault identification result to the uniform service management software platform 18 according to the fault identification result, a fault information problem stored in the knowledge base and a processing scheme corresponding to the fault information problem.

In this embodiment, the uniform service management software platform 18 is configured to perform the processing scheme corresponding to the fault identification result.

In an embodiment, the system further includes an interpreter, and the interpreter is connected to the monitor 14 and the context retriever 13 and configured to provide a service for the monitor 14 and the context retriever 13, where the service includes a translation of a high-level programming language.

In an embodiment, the knowledge base 17 is configured to update a stored content.

In an embodiment, the basic resource information includes at least one of network device information, database information, physical host information or virtual host information, or application system information.

In an embodiment, the system further includes a uniform entry module connected to the data center and configured to display information of the data center.

In an embodiment, the data analyzer 12 is further connected to the data center 10, and the data analyzer 12 is configured to analyze the basic resource information and determine whether the information of the information node of the data center 10 is updated in a following manner: comparing the basic resource information with historical basic resource information stored in the knowledge base 17, and determining whether the information of the information node of the data center 10 is updated according to a comparison result.

In an embodiment, the context information is collected by the information node of the data center 10. The step in which the context retriever 13 retrieves the context information includes that: in a case where the context retriever 13 confirms that new context information is collected by the information node of the data center 10, the context retriever 13 retrieves the collected new context information in the context information stored in the knowledge base 17.

According to the knowledge base information awareness system based on the operation and maintenance of the data center provided by the embodiments of the present application, in a case where the monitor monitors that the context information is updated and/or that the information node of the data center is updated according to the determination result and the update parameter, a processing scheme is sent to the uniform service management software platform according to the fault information problem stored in the knowledge base in advance and a processing step and processing scheme corresponding to the fault information problem, and the uniform service management software platform performs the processing scheme. Therefore, the intelligent monitoring of the device of the data center is achieved, automatic management and operation and maintenance such as automatic alarm and automatic control can be achieved based on the update and change of the context information and/or the information node, the efficiency of the operation and maintenance is greatly improved, and the labor is reduced.

1. A knowledge base information awareness method based on operation and maintenance of a data center, comprising:
collecting, by a data collector, basic resource information of the data center;
analyzing, by a data analyzer, the basic resource information, and determining whether information of an information node of the data center is updated to obtain a determination result and an update parameter;
establishing, by a context retriever, an index for context information stored in a knowledge base, and retrieving the context information to obtain a retrieval result;
monitoring, by a monitor, an update of the context information according to the retrieval result, and monitoring, by the monitor, an update of the information node according to the determination result and the update parameter;
in a case where the monitor monitors that at least one of the context information or the information node is updated, performing, by the monitor, an adaptive management through an operation and maintenance related body, and triggering a problem manager; wherein the adaptive management comprises a fault identification of the information node of the data center;
sending, by the problem manager, a processing scheme corresponding to the fault identification result to a uniform service management software platform according to a fault identification result, a fault information problem stored in the knowledge base and a processing scheme corresponding to the fault information problem; and
performing, by the uniform service management software platform, the processing scheme corresponding to the fault identification result.

2. The method of claim 1, further comprising:
providing, by an interpreter, a service for the monitor and the context retriever, wherein the service comprises a translation of a high-level programming language.

3. The method of claim 1, further comprising:
updating, by the knowledge base, a stored content.

4. The method of claim 1, wherein the basic resource information comprises at least one of network device information, database information, physical host information or virtual host information, or application system information.

5. The method of claim 1, further comprising:
displaying, by a uniform entry module, information of the data center.

6. The method of claim 1, wherein analyzing, by the data analyzer, the basic resource information, and determining whether the information of the information node of the data center is updated comprises:
comparing, by the data analyzer, the basic resource information with historical basic resource information stored in the knowledge base, and determining whether the information of the information node of the data center is updated according to a comparison result.

7. The method of claim 1, wherein the context information is collected by the information node of the data center; and wherein retrieving, by the context retriever, the context information comprises:
retrieving, by the context retriever, in a case of confirming that new context information is collected by the information node of the data center, the new context information in the context information stored in the knowledge base.

8. A knowledge base information awareness system based on operation and maintenance of a data center, comprising: the data center, a data collector, a data analyzer, a knowledge base, a context retriever, a monitor, an operation and maintenance related body, a problem manager and a uniform service management software platform; wherein,
the data collector is connected to the data center and configured to collect basic resource information of the data center;
the data analyzer is connected to the data collector and configured to analyze the basic resource information and determine whether information of an information node of the data center is updated to obtain a determination result and an update parameter;
the context retriever is connected to the knowledge base and configured to establish an index for context information stored in the knowledge base and retrieve the context information to obtain a retrieval result;
the monitor is connected to the context retriever, the data analyzer, the operation and maintenance related body and the problem manager, and the monitor is configured to monitor an update of the context information according to the retrieval result, monitor an update of the information node according to the determination result and the update parameter, and in a case of monitoring that at least one of the context information or the information node is updated, perform an adaptive management through the operation and maintenance related body and trigger the problem manager; wherein the adaptive management comprises a fault identification of the information node of the data center;
the problem manager is connected to the uniform service management software platform and configured to send a processing scheme corresponding to the fault identification result to the uniform service management software platform according to a fault identification result, a fault information problem stored in the knowledge base and a processing scheme corresponding to the fault information problem; and
the uniform service management software platform is configured to perform the processing scheme corresponding to the fault identification result.

9. The system of claim 8, further comprising:
an interpreter, which is connected to the monitor and the context retriever, and configured to provide a service for the monitor and the context retriever, wherein the service comprises a translation of a high-level programming language.

10. The system of claim 8, wherein the knowledge base is configured to update a stored content.

11. The system of claim 8, wherein the basic resource information comprises at least one of network device information, database information, physical host information or virtual host information, or application system information.

12. The system of claim 8, further comprising:
a uniform entry module connected to the data center and configured to display information of the data center.

13. The system of claim 8, wherein the data analyzer is further connected to the data center, the data analyzer is configured to analyze the basic resource information and determine whether the information of the information node of the data center is updated in a following manner:
comparing the basic resource information with historical basic resource information stored in the knowledge base, and determining whether the information of the information node of the data center is updated according to a comparison result.

14. The system of claim 8, wherein the context information is collected by the information node of the data center; and the context retriever is further connected to the knowledge base and configured to retrieve the context information in a following manner:
in a case of confirming that new context information is collected by the information node of the data center, retrieving the new context information in the context information stored in the knowledge base.
